(19) United States
(12) Patent Application Publication
(10) Pub. No.: US 2009/0213483 A1
(43) Pub. Date: Aug. 27, 2009

(54) Magnetic head drive device and magnetic recording/reproducing device using this drive device

(75) Inventors: Junko Matsui, Kawasaki (JP); Yoshihiro Amemiya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/259,764

(22) Filed: Oct. 28, 2008

(30) Foreign Application Priority Data
Feb. 22, 2008 (JP) 2008-41559

(51) Int. Cl. G11B 5/02

(52) U.S. Cl. 360/59; G9B/5.026

(57) ABSTRACT

A magnetic head drive device drives a heater element for controlling a protrusion amount of the magnetic head. The heater drive circuit of the heater element of the magnetic head, in which a read element, a write element and a heat element is included, is constructed by the PWM modulation method. A pair of heater wiring lines is made of a path in which the signal polarity is inverted. Therefore cross-talk noise, to the read wiring line, can be decreased even if PWM driving is executed.

### CROSS-REFERENCE TO RELATED APPLICATIONS

This application is based upon and claims the benefit of priority of the prior Japanese Patent Application No. 2008-041559, filed on Feb. 22, 2008, the entire contents of which are incorporated herein by reference.

### FIELD

The present invention relates to a magnetic head drive device for driving a heater element to control a magnetic spacing of a magnetic head with respect to a magnetic recording medium, and a magnetic recording/reproducing device using this device.

### BACKGROUND

In recent years as information processing advances, securing data reliability has become an important issue. Particularly in a magnetic recording/reproducing device, the most important function concerns recording data on media with certainty. In a magnetic disk device, magnetic data is stored according to the inversion of write current, which is generated based on the data. This data is read by a read head (specifically, an MR head that utilizes the magneto-resistance effect), and the magnetic data is converted into electric signal data, and sent to a controller.

When the magnetic disk device shifts to the write operation, a read channel enters write mode by a write gate signal from the controller, and write current, which depends on the data, is supplied to a write head.

When the ambient temperature is low, the temperature of the write head is low before writing, and rises once writing starts due to write current which is applied. This means that a transient temperature stress is applied to the magnetic pole of the write head, and as a result, thermal expansion occurs to the write magnetic pole, and the magnetic pole protrudes in the media direction. This is generally called “PTP (Pole Tip Protrusion)”.

When this phenomena occurs, the magnetic pole, which does not protrude at the beginning of data write, gradually protrudes as the time of applying the write current elapses. Hence the magnetic spacing of the magnetic head, which is comprised of a write head and a read head, is relatively large at the beginning of a data write, and decreases as writing progresses.

This means that the write capability is lower at the beginning of data write than at the end of data write. This is recognized as the deterioration of the overwrite performance. In other words, the capability to delete data previously written on tracks by the write operation is lower as the operation becomes closer to the beginning of data write, where the previous data is appeared as noise during the read operation, and the data rate deteriorates as a result.

If the write head gradually protrudes, the overwrite performance generally improves as the magnetic head becomes closer to the media during writing. Particularly when the magnetic disk device is used under a low temperature environment, the temperature difference between the beginning and the end of data write increases, and the write performance at the beginning of data write drops considerably.

Furthermore, recently as the track density and recording density improve, decreasing the magnetic spacing of the magnetic head is indispensable (e.g. about 10 nanometers is demanded). This makes it difficult to make the magnetic spacing between the magnetic recording media and magnetic head element constant. For example, a magnetic head floats using the wind pressure generated by the rotation of a magnetic disk, so such environment conditions as altitude (air pressure) and ambient temperature changes the magnetic spacing, causing a dispersion of the magnetic spacing.

The irregularities of characteristics of each head, position of a cylinder and set value of write current, among other factors, also causes the dispersion of magnetic spacing. These factors sometime may cause a drop in the write performance and a deterioration of the signal quality, or could cause element deterioration due to contact with media, or at worse damage of the element.

In order to improve the overwrite characteristic, a method for improving overwrite by increasing the write current for a predetermined time from the start of writing has been proposed (e.g. Japanese Patent Application Laid-Open NO. 2004-281012 (FIG. 2) and U.S. Pat. No. 6,798,598 (FIG. 2)). Although this method simply quickens the head protrusion time immediately after the start of writing, it is difficult to solve the problem of the deterioration of the error rate due to insufficient overwrite in the top sector because of the limitation of the maximum value of the write current and the limitation of the allowable maximum current value of the write element.

To solve this, a method for installing a heater inside the magnetic head and controlling a protruding amount of the magnetic head using the heat generated by the heater has been proposed (e.g. Japanese Patent Application Laid-Open No. H5-020635 (FIG. 1, FIG. 3, FIG. 5)).

Another prior art which has been proposed is a heater installed in a magnetic head, and heat power is applied to the heater when an adjustment of the magnetic spacing is required, immediately before writing, for example, and at the same time, heat power is temporarily increased so as to decrease the protrusion response time (Japanese Patent Application Laid-Open No. 2004-342151 (FIG. 7), and US Patent Publication 2005/0057841 (FIG. 7)).

A linear control type circuit is used (e.g. Japanese Patent Application Laid-Open No. 2007-26565 (FIG. 2)) for a drive circuit of a heater of a conventional magnetic head. In other words, current is supplied to a heater (resistor) installed in the head from a current source via a voltage adjustment resistor and transistor. Also the current and voltage of the heater are monitored and converted into power, in order to supply a predetermined power amount to the heater, and an error of the converted power amount and the predetermined power amount is computed so that the transistor is controlled by the error. In other words, the supply power amount of the heater is linearly controlled to the predetermined power amount by feedback control.

In magnetic recording/reproducing devices, where in recent years power consumption is increasing due to an increase in density and speed, a decrease in power consumption is demanded. With the prior art, however, the conversion efficiency is low because the transistors are controlled linearly. For example, in the case of using a heater installed in a magnetic head, 3 mW to 12 mW, which is most frequently used, is set, and if the heater resistance is 50Ω, the voltage applied to the heater is about 0.39 V to 0.77 V.

5.0 V is normally used for the power voltage in a magnetic recording device, so the heater drive circuit is applied 5.0 V as the power supply voltage, but the output of the heater drive circuit becomes 0.39 V to 0.77 V. That is, the voltage difference between input and output is large and the power efficiency is low. In other words, excessive power is consumed.

Also, because of linear driving, analog transistors are required, and the withstand voltage of the transistors must be high since a relatively large current is supplied. Such a transistor with high withstand voltage takes a relatively large area, so the circuit scale increases, and a cost increase is inevitable. In particular, when the heater drive circuit is integrated in a head IC, as seen in the one-chip integration trend of recent years, it is difficult to add other new circuits.

### SUMMARY

With the foregoing in view, it is an object of the present invention to provide a magnetic head drive device and magnetic recording/reproducing device to drive a heater element for controlling a protrusion amount of the magnetic head with improved power efficiency, and to prevent the influence of driving on read/write signals.

It is another object of the present invention to provide a magnetic head drive circuit and a magnetic recording/reproducing device to drive a heater element for controlling the protrusion amount of the magnetic head with improved power efficiency and for preventing the influence of driving on read/write signals, with a simple configuration.

In order to achieve these object, a magnetic recording/reproducing device includes: a magnetic recording medium, which rotates; a magnetic head, in which a write element and a read element are separated and a heater element is built-in; an actuator, which moves the magnetic head in a radius direction of the magnetic recording medium; a read amplifier, which is connected to the read element via a pair of read wiring lines and amplifies a signal of the read element; a write driver, which is connected to the write element via a pair of write wiring lines and drives the write element; and a heater drive circuit, which is connected to the heater element via a pair of heater wiring lines and drives the heater element by a pulse width modulation method. And the pair of heater wiring lines have a path in which signal polarity is inverted and a path in which signal polarity is not inverted with respect to the read wiring lines.

In order to achieve these object, a magnetic head drive device includes: a read amplifier, which is connected to a read element via a pair of read wiring lines and amplifies a signal of the read element; a write driver, which is connected to a write element via a pair of write wiring lines and drives the write element; and a heater drive circuit, which is connected to a heater element via a pair of heater wiring lines and drives the heater element by a pulse width modulation method. And the pair of heater wiring lines have a path in which signal polarity is inverted and a path in which signal polarity is not inverted with respect to the read wiring lines.

In order to achieve these object, a magnetic recording/reproducing device, includes: a magnetic recording medium, which rotates; a magnetic head, in which a write element and a read element are separated and a heater element is built-in; an actuator, which moves the magnetic head in a radius direction of the magnetic recording medium; a read amplifier, which is connected to the read element via a pair of read wiring lines and amplifies a signal of the read element; a write driver, which is connected to the write element via a pair of write wiring lines and drives the write element; and a heater drive circuit, which is connected to the heater element via a pair of heater wiring lines and drives the heater element by a pulse width modulation method. And the heater drive circuit outputs pulse width modulation current of the heater element having a center tap as a differential current.

In order to achieve these object, a magnetic head drive device includes: a read amplifier, which is connected to a read element via a pair of read wiring lines and amplifies a signal of the read element; a write driver, which is connected to a write element via a pair of write wiring lines and drives the write element; and a heater drive circuit, which is connected to a heater element via a pair of heater wiring lines and drives the heater element by a pulse width modulation method. And the heater drive circuit outputs a pulse width modulation current of the heater element having a center tap as a differential current.

In the present invention, it is preferable that the pair of heater wiring lines are twisted in at least one location of the wiring lines which form a path in which said signal polarity is inverted and a path in which said signal polarity is not inverted.

In the present invention, it is preferable that the pair of read wiring lines have a path in which a signal polarity is inverted and a path in which a signal polarity is not inverted, with respect to said write wiring lines.

In the present invention, it is preferable that the magnetic recording/reproducing device further includes a transmission line for connecting a head IC, which has the read amplifier, the write driver and the heater drive circuit, and the magnetic head, wherein the pair of write wiring lines, read wiring lines and heater wiring lines are disposed in the transmission line.

In the present invention, it is preferable that the pair of heater wiring lines have at least two transmission plates, each of which has a pair of separate conductor patterns, and one of said conductor patterns is connected to the other conductor pattern, and the other conductor pattern is connected to the one of the conductor patterns at an overlapped portion of edges of the two transmission plates.

In the present invention, it is preferable that the pair of heater wiring lines have a first insulation substrate having a first conductor pattern formed in a first diagonal direction, and a second insulation substrate having a second conductor pattern which is formed in the first insulation substrate via an insulation layer, in a second diagonal direction which is different from the first diagonal direction, and edges of the first conductor pattern and the second conductor pattern are inter-connected.

In the present invention, it is preferable that a conductive layer which is insulated from the first conductive pattern is disposed on the first insulation substrate.

In the present invention, it is preferable that a conductive layer which is insulated from the second conductive pattern is disposed on the second insulation substrate.

In the present invention, it is preferable that the heater drive circuit outputs a plus-side pulse width modulation current to one of the pair of heater wiring lines, and outputs a minus-side pulse width modulation current, which is in a differential relationship with the plus-side pulse width modulation current, to the other of the pair of heater wiring lines.

The heater drive circuit of the heater element of the magnetic head is constructed by the PWM modulation method, so a pulse width can be adjusted with respect to a predetermined pulse cycle in order to control the amount of power, and therefore the heating of the heater can be controlled with low power consumption. Also the heater drive circuit is comprised of logic system circuits, so the size of the transistors is decreased and the circuit scale can be small. This makes it easier to integrate other functional circuits in the head IC, which is effective to increase the functions of the head IC. Moreover, a pair of heater wiring lines are made of a path in which the signal polarity is inverted and a path in which the signal polarity is not inverted with respect to the read wiring lines, and the heater drive circuit has a configuration to output the pulse width modulation current of the heater element, which has a center tap, as a differential current, therefore cross-talk noise, to the read wiring line, can be decreased even if PWM driving is executed.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram depicting an embodiment of a magnetic recording/reproducing device of the present invention;

FIG. 2 is a configuration diagram of a magnetic head in FIG. 1;

FIG. 3 is a configuration diagram of a preamp in FIG. 1;

FIG. 4 is a block diagram of a heater drive circuit in FIG. 3;

FIG. 5 shows a current waveform when the configuration in FIG. 4 is used;

FIG. 6 is a diagram depicting cross-talk based in the configuration of FIG. 3;

FIG. 7 is a diagram depicting a first embodiment of the transmission line of the present invention;

FIG. 8 is a diagram depicting a second embodiment of the transmission line of the present invention;

FIG. 9 is a diagram depicting a third embodiment of the transmission line of the present invention;

FIG. 10 is a diagram depicting a configuration of a fourth embodiment of the transmission line of the present invention;

FIG. 11 is an exploded view of the configuration of FIG. 10;

FIG. 12 is a diagram depicting a configuration of a fifth embodiment of the transmission line of the present invention;

FIG. 13 is a diagram depicting a configuration of a sixth embodiment of the transmission line of the present invention;

FIG. 14 is a diagram for explaining PWM waveform and inductive current in the comparative example;

FIG. 15 is a diagram for explaining PWM waveform and an inductive current according to the embodiment of the present invention;

FIG. 16 is a diagram depicting a configuration of a seventh embodiment of the transmission line of the present invention

FIG. 17 is a block diagram depicting a heater drive according to an embodiment of the present invention; and

FIG. 18 is a waveform diagram in the configuration of FIG. 17.

### DESCRIPTION OF EMBODIMENTS

Embodiments of the present invention will now be described in the sequence of configuration of a magnetic recording/reproducing device, configuration of magnetic head drive device, embodiment of transmission line, embodiment of heater drive method, and other embodiments, however the present invention is not limited to these embodiments.

### (Magnetic Recording/Reproducing Device)

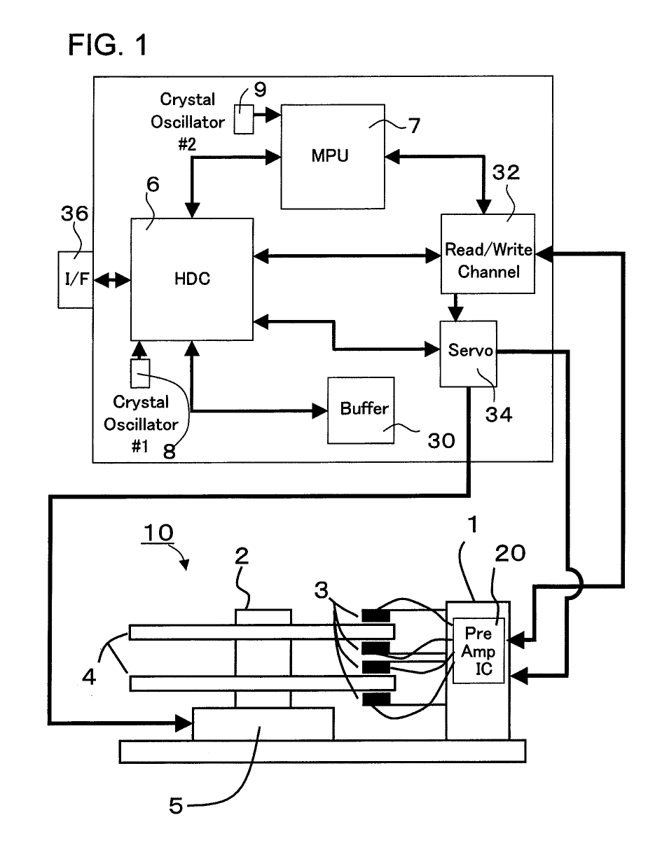

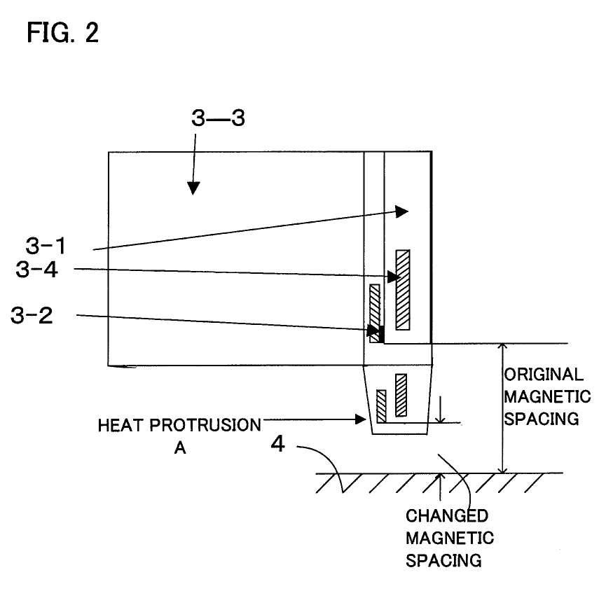

FIG. 1 is a block diagram depicting an embodiment of a magnetic recording/reproducing device of the present invention, and FIG. 2 is a detailed configuration diagram of a magnetic head in FIG. 1. FIG. 1 shows a magnetic disk device as an example of the magnetic recording/reproducing device. As FIG. 1 shows, a magnetic disk 4, which is a magnetic storage media, is installed on a rotation axis 2 of a spindle motor 5 in a magnetic disk drive mechanism 10. The spindle motor 5 rotates the magnetic disk 4. An actuator (VCM) 1 has a magnetic head 3 at the tip of an arm and suspension (flexure), and moves the magnetic head 3 in a radius direction of the magnetic disk 4.

The actuator 1 is configured by a voice coil motor (VCM), which rotates around a rotation axis. In FIG. 1, two magnetic disks 4 are installed in the magnetic disk device, and four magnetic heads 3 are simultaneously driven by a same actuator 1.

The magnetic head 3 is comprised of a read element and a write element. In the magnetic head 3, the read element, including a magneto-resistance (MR) element, is layered on the slider, and the write element, including a write coil, is layered thereon.

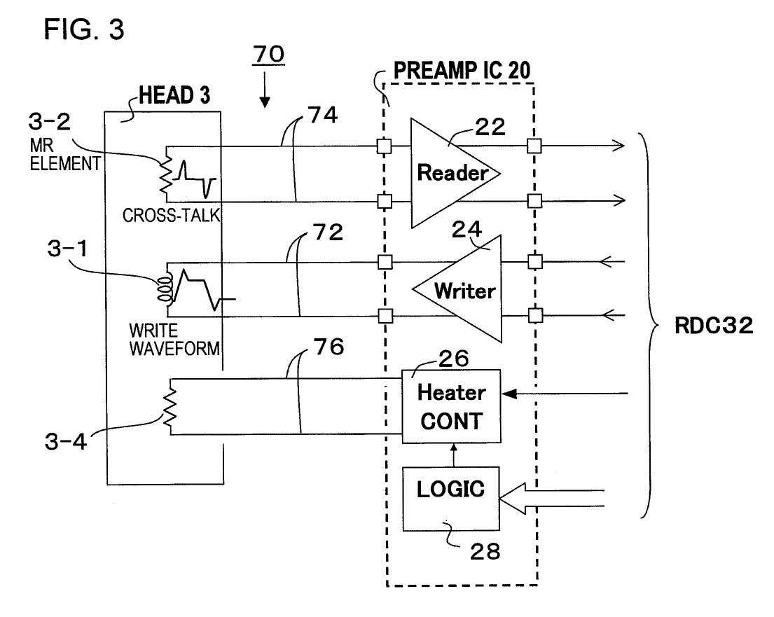

A preamp (head IC) 20, which will be described in FIG. 3, is disposed on the side face of the VCM 1 of the magnetic disk drive mechanism 10.

A hard disk controller 6, MPU (micro-controller) 7, clock sources 8 and 9, buffer circuit 30, read/write channel circuit 32 and servo circuit 34 are disposed on a control printed board (control circuit portion) 20.

The read/write (R/W) channel circuit 32 which is connected to the preamp 20, controls the read and write of the magnetic head 3. The R/W channel circuit 32 has a write circuit which supplies a write signal to the magnetic head 3 and a read circuit which receives a read signal from the magnetic head 3 and demodulates the signal. The servo circuit 34 has a spindle motor drive circuit for driving the spindle motor 5, and a VCM drive circuit for driving the voice coil motor (VCM) 1 by a drive signal from the MPU 7.

The hard disk controller (HDC) 6 communicates with a host via an interface 36, judges a position in one track based on a sector number of a servo signal, and records and reproduces data. The random access memory for buffer (RAM) 30 temporarily stores read data and write data. The HDC 6 communicates with the host using such an interface 36 as USB (Universal Serial Bus), ATA (AT Attached) and SCSI (Small Component System Interface).

The micro-controller (MPU) 7 analyzes a command from the HDC 6, and performs various control processings via the HDC 6. For this, the MPU 7 has a read only memory (ROM) for storing various programs, and a random access memory (RAM). The MPU 7 also receives a servo signal of a read signal from the read/write channel circuit 32, detects a current position, and performs position control to control the driving of the voice coil motor (VCM) 1 according to an error from the target position.

A servo signal (position signal) is disposed in each track on this magnetic disk 4 from the outer circumference to the inner circumference with an equal interval in the circumference direction. Each track consists of a plurality of sectors, and a position signal consists of a servo mark Servo Mark, track number Gray Code, index Index and offset information (servo burst) PosA, PosB, PosC and PosD.

This magnetic disk drive mechanism 10 has a plurality of magnetic disks 4, which are stacked on the spindle motor 5 and rotated in a predetermined direction.

As FIG. 2 shows, the magnetic head 3 is comprised of a read element 3-2 (magneto-resistance element, such as TMR) and a write element (induction element) 3-1 disposed on the slider 3-3. The slider 3-3 is held by a suspension, which is not illustrated.

The suspension (flexure) is mechanically secured to a carriage arm of the VCM 1, and a bearing, magnet of the voice coil motor and coil are installed on the carriage arm. The VCM 1 moves with the bearing as the center of rotation. By this, the magnetic head 3 moves along an arbitrary track (cylinder) instructed by the controller, and reads/writes data from/to the media 4 rotating by the spindle motor 5 based on the specified data format.

The head slider 3-3 slides on air over the rotating disk 4, and forms an air bearing on the surface of the disk 4 and the surface of the slider 3-3 facing thereto, and the head slider 3-3 maintains the floating position by a negative pressure generated from this and the spring force of a gimbal portion of the suspension.

A heater 3-4 is installed in an area close to the head portions 3-1 and 3-2. Here a resistor 3-4 is installed next to the write coil of the write element 3-1 via an insulation layer. By this, a protrusion A, similar to the write coil 3-1, can be generated.

The space between the bottom end of the read element 3-2 and the surface of the magnetic disk 4 is the original magnetic spacing; and the space between the bottom end of the protrusion A and the surface of the magnetic disk 4 is the magnetic spacing reduced by the protrusion.

### (Magnetic Head Drive Device)

FIG. 3 is a block diagram of the preamp (head IC) 20 and the head 3 in FIG. 1. As FIG. 3 shows, the preamp 20 has a read amplifier 22 which amplifies a read signal from the read element 3-2 and outputs it to the read channel circuit 32, a write driver 24 which amplifies a write signal from the read channel circuit 32 and supplies it to the write coil 3-1, a heater drive circuit 26 which receives a predetermined power amount from the read channel circuit 32 and drives the heater element 3-4 of the magnetic head 3, and a logic circuit 28 which performs the setup of the read amplifier 22, write driver 24 and heater drive circuit 26.

The logic circuit 28 also has a circuit to detect contact to the media based on the output of the read element 3-2 and a head switching circuit.

As FIG. 1 shows, the preamp 20 is installed to the VCM 1, and the head 3 is installed at the tip of the arm of the VCM 1, so the preamp 20 and the head 3 are connected via a transmission line 70. The transmission line 70 has a pair of read lines 74 which connect the read element 3-2 and the read amplifier 22, a pair of write lines 72 which connect the write coil 3-1 and the write driver 24, and a pair of heater lines 76 which connect the heater element 3-4 of the magnetic head 3 and the heater drive circuit 26.

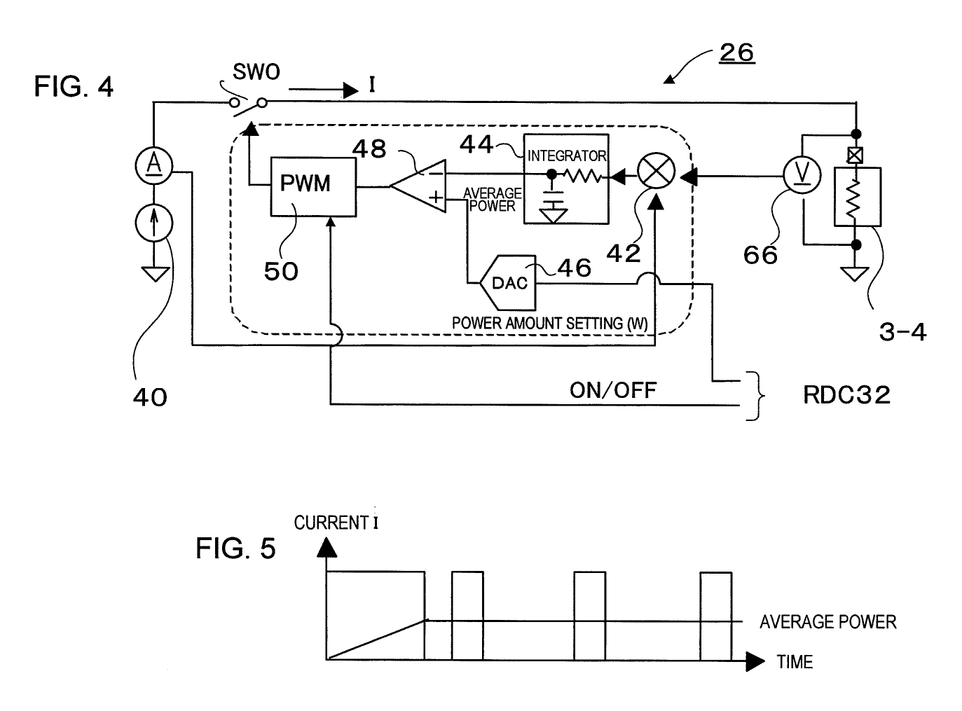

FIG. 4 is a block diagram of a PWM type heater drive circuit in FIG. 3, and FIG. 5 shows a current waveform when the configuration in FIG. 4 is used. As FIG. 4 shows, the heater drive circuit 26 has a voltage detection circuit 66 which detects voltage at both ends of the heater 3-4, a multiplication circuit 42 which multiplies the current of the current source 40 by the detected voltage, and outputs the power amount, and an integrator 44 which averages the power amount of the multiplication circuit 42 and outputs the average power.

The heater drive circuit 26 also has a digital/analog converter (DAC) 46 which converts a predetermined power value from the read channel circuit 32 into an analog value, an error amplifier 48 which outputs an error between the predetermined power amount and the detected power amount, a pulse width modulation circuit (PWM) 50 which generates a switch signal with a pulse width according to the error amount of the error amplifier 48, and a switch SW0 which is operated by an ON/OFF switch signal from the PWM circuit 50, and supplies the current I of the current source 40 to the heater 3-4.

This switch SW0 is configured by a transistor, and forms a feedback loop with the voltage detection circuit 66, multiplication circuit 42, integrator 44, DAC 46 and error amplifier 48.

The read channel circuit 32 changes the predetermined power amount according to the environment conditions, such as the temperature of the device or read characteristics and write characteristics. When a plurality of magnetic heads use one heater drive circuit, a predetermined power amount corresponding to the characteristics of the specified magnetic head is set.

As FIG. 5 shows, in a current waveform to drive the heater 3-4, the current value of the current source 40 is the maximum current, and the PWM circuit 50 adjusts the on-duty ratio of the PWM wave according to the output power. When the switch SW0 is operated by this ON/OFF switch signal, drive current with a width according to the power error amount is supplied to the heater 3-4.

When the heat of the heater is decreased to half, for example, in order to perform ON/OFF control, the pulse width is set to half with respect to a predetermined pulse cycle, then the power consumption efficiency improves. In other words, heating of the heater can be controlled with low power consumption.

For example, in the case of a conventional linear circuit, if the predetermined power amount is the minimum 3 mW, the current Imin=13 mA, voltage Vin=5.0 V, Iout=5.6 mA, Vout=0.53 V. And efficiency is 10% or less, and 65 mW of power is required. But in the case of a PWM type drive circuit, only 3.8 mW is required to acquire a 3 mW output, and conversion efficiency can be improved to 70 to 80%.

The PWM circuit 50 is basically a logic circuit, which generates binary output, and the switch SW0 is also a binary driving transistor, so half of the circuits of the heater drive circuit 26 are logic circuits. This means that the size of the transistor can be decreased, and the circuit scale becomes small.

The head IC 20, in particular, is installed at the magnetic disk drive mechanism 10 side, independently from other circuits, so the size thereof is limited. Decreasing the circuit scale of the heater drive circuit 26 makes it easier to integrate other functional circuits in the head IC 20, and is effective to increase the functions of the head IC 20.

### (Embodiment of Transmission Line)

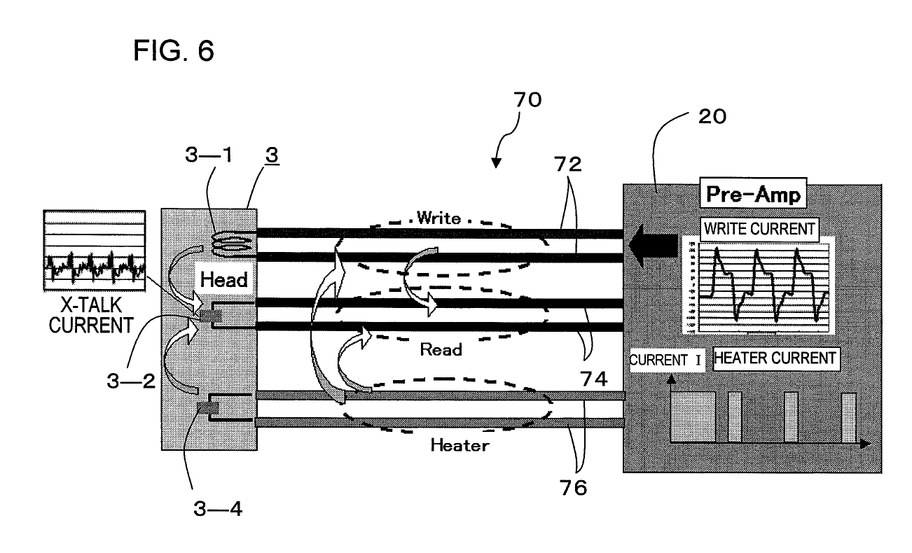

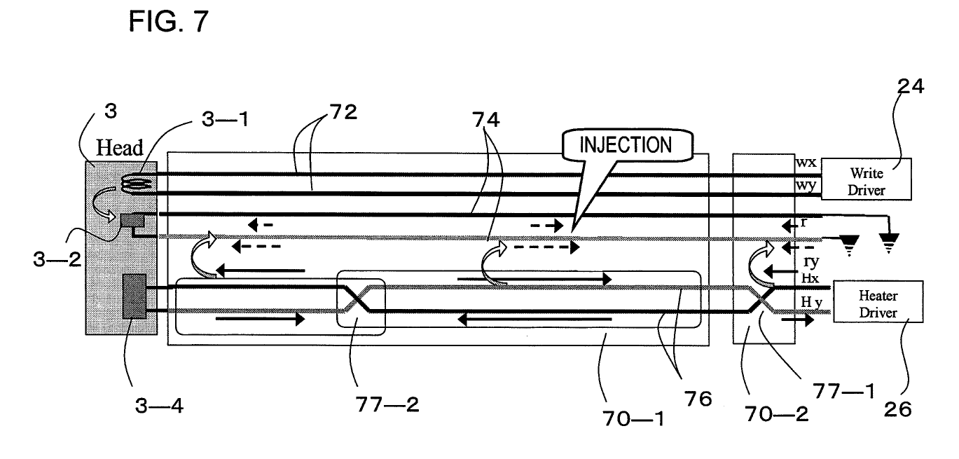

FIG. 6 is a diagram depicting cross-talk based on the PWM method, and FIG. 7 is a diagram depicting a first embodiment of the transmission line of the present invention. As FIG. 6 shows, when writing data, current for a write signal flows from the preamplifier 20 to the write coil 3-1 via the write lines 72 of the transmission line 70.

At this time, cross-talk current is generated in the read lines 74 of the transmission line 70 due to inter-line coupling by current which flows through the write lines 72, since the line space between write and read is narrow. Also as described in FIG. 2, inside the head 3, direct cross-talk current flows from the internal lines of the head or the coil to the MR element 32, since the MR element for reading 3-2 exists directly under the write coil 3-1.

A method for preventing cross-talk from the write line to the read element has been known. For example, a method for widening the space between the write line and read line (Japanese Patent Application Laid-Open No. 2000-123513), a method for disposing a ground line of a guard or a cover around the lines (Japanese Patent Application Laid-Open No. 2001-093248), and a method for weakening cross-talk by inverting the read lines at the connected portion of the head and the lines, or a connected portion in the middle of the lines (Japanese Patent Application Laid-Open No. 2007-149157) have been proposed.

As mentioned above, a conventional heater drive circuit is driven linearly, so no noise enters from the heater line to the signal line. Therefore noise which entered from the heater line was not considered, and only the coupling of the write current with the read line was handled. If the heater is driven by PWM in order to improve efficiency and heat problems in this state, noise is generated, and quality problems occur to the device, such as deterioration of the error rate and a drop in writing capability.

Hence, as shown in FIG. 7, heater lines 76 are structured such that the cross-talk generated at the rise of the PWM waveform (see FIG. 5) is cancelled by polarity inversion when the heater driver 26 is driven by PWM.

In FIG. 7, composing elements the same as FIG. 1 to FIG. 6 are denoted with the same symbols. As FIG. 7 shows, in the case of PWM driving, noise enters the read lines 74 (rx, ry) since pulse current flows into the heater lines 76 (Hx), so the signal line is affected. The cross-talk is generated by the change of voltage and current of the signal line.

When signal lines are adjacent to each other, the signal waveform is affected due to mutual interference, and noise and delay fluctuation are generated. This is called “cross-talk”. In the embodiment in FIG. 7, the signal (heater) lines 76, which are the influenced side, are twisted to prevent cross-talk. In other words, the positions of a pair of heater lines (signal lines) 76 are reversed in at least one location (two locations 77-1 and 77-2 in the case of FIG. 7).

Here current flows from the heater line 76 (Hx) of the transmission line 70-1 to the heater 3-4, and the current returns from the heater 3-4 via the heater line 76 (Hy) of the transmission line 70-2, so the directions of the current of the heater line 76 (Hx) and heater line 76 (Hy) are opposite. By changing the positions of the heater line 76 (Hx) and the heater line 76 (Hy) at the twist locations 77-1 and 77-2, polarity inversion is generated in the heater lines 76.

In FIG. 7, the heater line 76 (Hx) is closer to the read line 74 than the heater line 76 (Hy) in the area near the heater driver 26 (transmission line connection portion) 70-2, and the heater line 76 (Hy) becomes closer to the read line 74 than the heater line 76 (Hx) by reversing the positions of the heater line 76 (Hx) and the heater line 76 (Hy) at the twisted portion 77-1. In the same way, the heater line 76 (Hx) becomes closer to the read line 74 than the heater line 76 (Hy) by reversing the positions of the heater line 76 (Hx) and the heater line 76 (Hy) at the twisted portion 77-2 of the transmission line 70-1.

For this, a portion where the direction of the current is the same as the adjacent loop 74 and a portion where the direction of the current is opposite thereof are created on the heater lines 76. As a result, both an inductive noise (magnetic flux) where the directions of the current are the same, and an inductive noise (magnetic flux) where the directions of the current are opposite, are applied to the read lines 74 as cross-talk. Since the inductive currents (dotted lines in FIG. 7) due to the two inductive noises are in opposite directions, the inductive noises (magnetic flux) generated by current in the read lines 74 are cancelled.

In other words, by twisting the heater lines 76 and changing the polarity on the heater lines 76, the inductive noises are cancelled on the read lines 74, and cross-talk, generated by the PWM drive heater, can be suppressed.

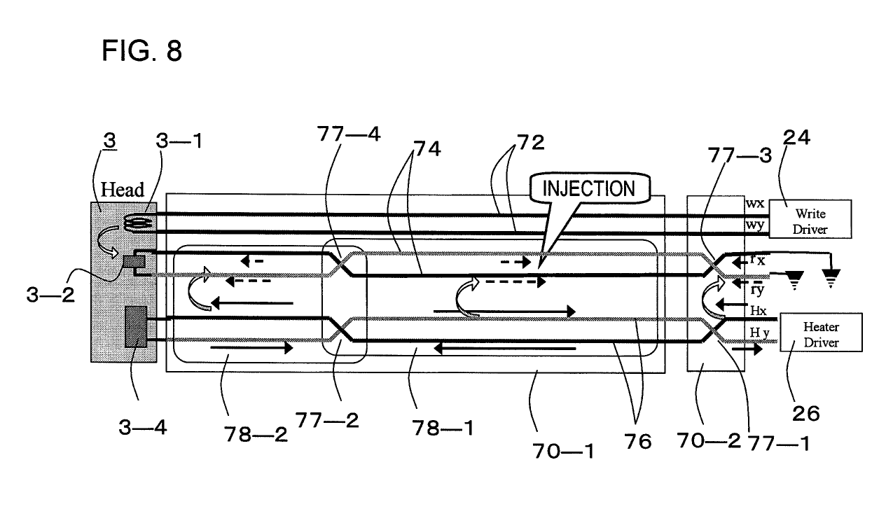

FIG. 8 is a diagram depicting a second embodiment of the transmission line of the present invention. In FIG. 8, composing elements the same as FIG. 7 are denoted with the same symbols. In this embodiment, polarity is changed not only for the heater lines 76, but also for the read lines 74 which are the receiving side of the cross-talk.

As FIG. 8 shows, positions of a pair of read lines 74 are reversed in at least one location (two locations, 77-3 and 77-4, in the case of FIG. 8). Here current flows from the read line 74 (rx) of the transmission line 70-1 to the read element 3-2, and the current returns from the read elements 3-2 via the read line 74 (ry) of the transmission line 70-1, so the directions of the current of the read line 74 (rx) and the read line 74 (ry) are opposite.

By changing the positions of the read line 74 (rx) and the read line 74 (ry) at the twist locations 77-3 and 77-4, polarity inversion is generated in the read lines 74. Thus a portion where the direction of the current is the same as the adjacent loop 76, and a portion where the direction of the current is opposite thereof are created in the read lines 74 as well.

As a result, both an inductive noise (magnetic flux) where the directions of the current are the same, and an inductive noise (magnetic flux) where the directions of the current are opposite, are applied to the read lines 74 as cross-talk. Since the inductive currents (dotted lines in FIG. 8) due to the two inductive noises are in opposite directions, the inductive noises (magnetic flux) generated by current in the read lines 74 are cancelled.

Because of this twist of the read lines 74, the read line 74 (rx) and the heater line 76 (Hy), which have opposite polarities, are adjacent to each other, and the read line 74 (ry) and the heater line 74 (Hx), which also have opposite polarities, are adjacent to each other. Since the current directions are opposite, the cancellation effect is even higher.

Furthermore, a portion where the direction of the current is the same as the adjacent loop (write lines) 72 and a portion where the direction of the current is opposite thereof are created on the read lines 74. As a result, both an inductive noise (magnetic flux) where the directions of the current from the write line 72 are the same, and an inductive noise (magnetic flux) where the directions of the current are opposite, are applied to the read lines 74 as cross-talk, so the inductive noise (magnetic flux) generated by the current of the write lines 72 can also be cancelled on the read lines 74.

In these twisted portions (cross-points) 77-2 and 77-4, the crossing lines must be insulated, so it is preferable that the line portions before and after the twisted portions 77-2 and 77-4 are formed on different plates 78-1 and 78-2, and these plates 78-1 and 78-2 are overlapped at the twisted portions, where the crossing lines are insulated.

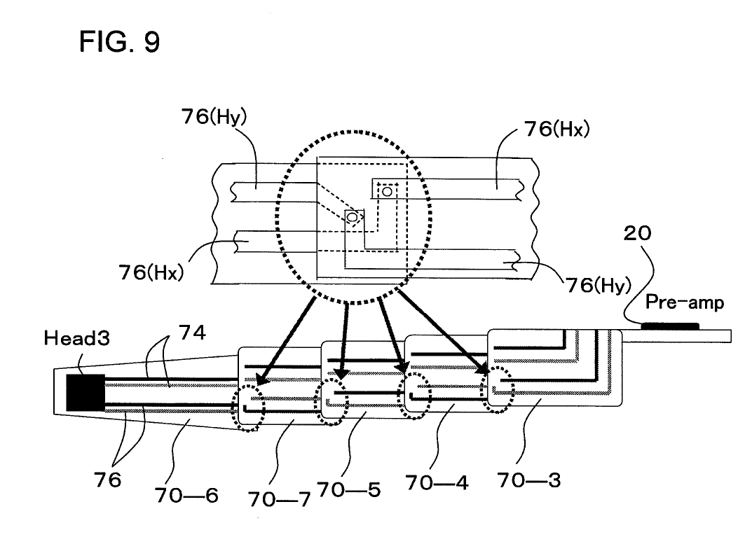

FIG. 9 is a diagram depicting a third embodiment of the transmission line of the present invention. In FIG. 9, composing elements the same as FIG. 8 are denoted with the same symbols. In FIG. 9, the write lines 72 are omitted, and only the read lines 74 and the heater lines 76 are shown, in order to describe the configuration to form cross-points.

The transmission line 70-1 in FIG. 9 has a first transmission plate 70-3 where the preamp 20 is mounted, a second transmission plate 70-6 which is a flexure where the head 3 is mounted, and third to fifth transmission plates 70-4, 70-5 and 70-7 installed there between. Each transmission plate 70-3 to 70-7 is overlapped and connected.

In this case, conductor wiring lines are formed on the insulator or dielectric transmission plates, so when a pair of wiring lines are crossed at an overlapped portion, the overlapped upper plate insulates between the wiring lines, and the crossing of the wiring lines can be easily created. In other words, the transmission plates are overlapped creating a double-deck structure at the cross-points.

In this embodiment as well, polarity may be changed not only for the heater lines 76, but also for the read lines 74, which are the receiving sides of cross-talk, and many cross-points, that is the polarity change portions, can be created, therefore cross-talk can be further suppressed.

The transmission line 70-1 may be separated into each transmission plate for the number of crossing times, so that the cross points of the wiring line are formed by connection.

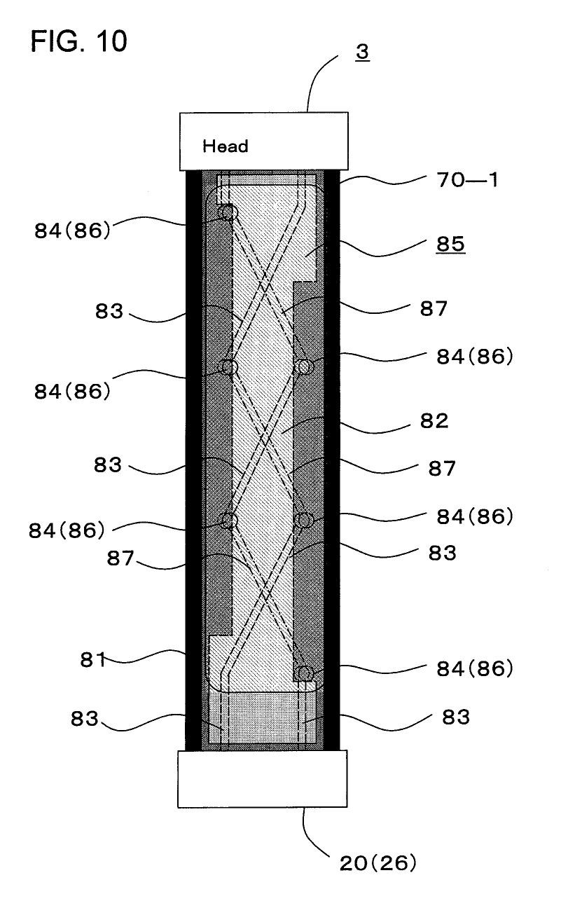

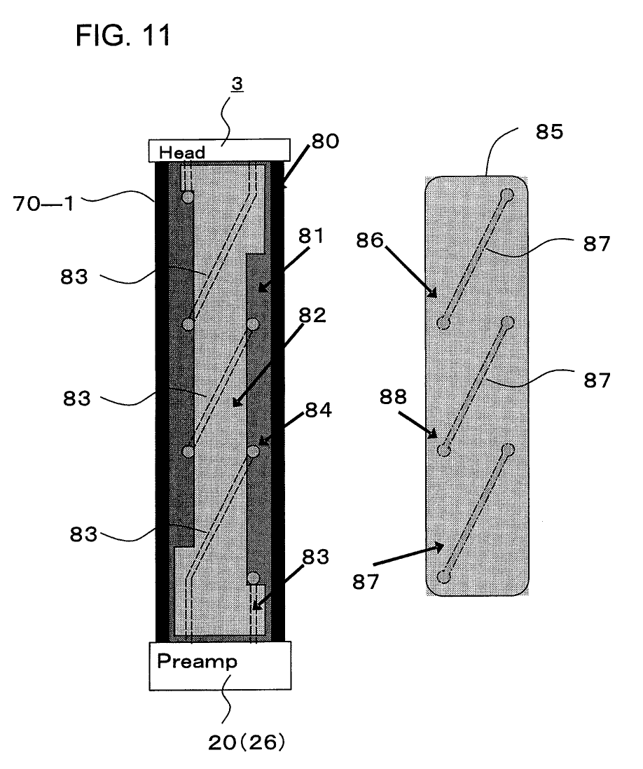

FIG. 10 is a diagram depicting a configuration of a fourth embodiment of the transmission line of the present invention, and FIG. 11 is an exploded view thereof. In FIG. 10, composing elements the same as FIG. 7 to FIG. 9 are denoted with the same symbols. FIG. 10 and FIG. 11 depict another configuration of forming many cross points on one transmission line 70-1, where the write lines 72 and the read lines 74 are omitted, and only the heater lines 76 are shown.

As FIG. 11 shows, in the transmission line 70-1 located on a suspension, an insulation layer (e.g. polyimide) 81 is formed on a conductor base (e.g. stainless steel) 80, and wiring lines (conductor, e.g. copper) 83 are formed diagonally on the insulation layer 81. The wiring lines, except for the pads 84 at the edge of the wiring lines 83, are covered by an insulation cover layer 84.

In a flexible printed board 85, shown at the right of FIG. 11, the wiring lines 87 are formed diagonally in an opposite direction of the diagonal direction of the wiring lines 83 on the transmission line 70-1 of the suspension on the insulation layer 86 (front side in FIG. 11). The pads 88 at the edge of the wiring lines 87 are exposed.

When the flexible printed board 85 in FIG. 11 is overlapped so that the wiring lines 83 and 87 face each other, each wiring line (pattern) 83 and 87 is connected via the pads 84 and 88, and a transmission line having cross points can be created, as shown in FIG. 10. Solder is used for the connection. The wiring lines 83 and 87 are electrically insulated by the insulation layer 82.

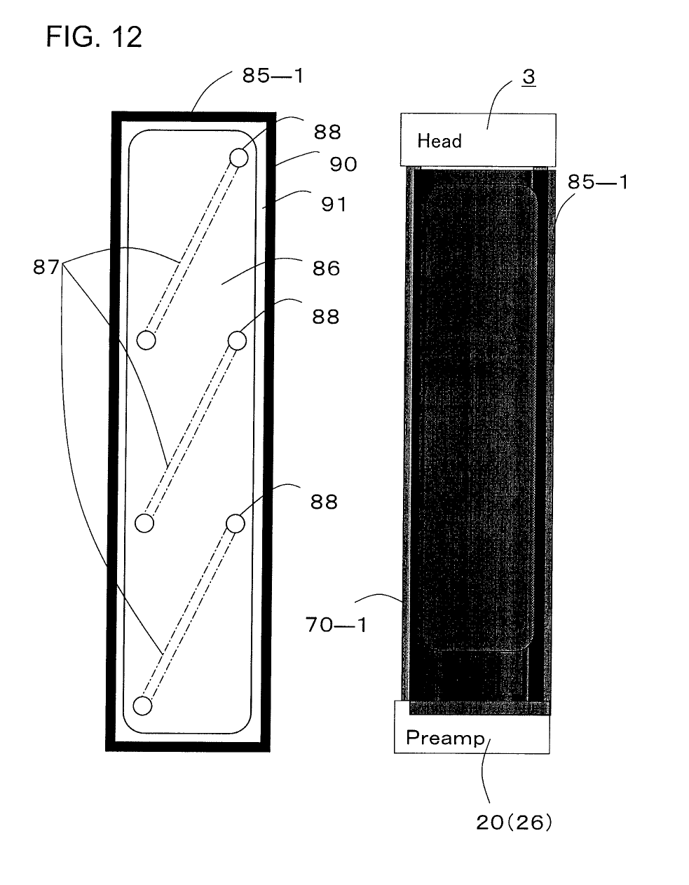

FIG. 12 is a diagram depicting a configuration of a fifth embodiment of the transmission line of the present invention. FIG. 12 is an example of using a substrate where a cover, made of a conductor 90, or an insulator 91, is disposed on flexible printed boards 86, 87 and 88, to control impedance to provide a good transmission line characteristic, instead of a combination with the flexible printed board 85 in FIG. 11.

In the substrate 85-1 shown at the left in FIG. 12, an insulation layer 91 is formed on a conductor 90, an insulation layer 86 is formed on this insulation layer 91, and wiring lines 87 are formed on this insulation layer 86 diagonally in an opposite direction of the diagonal direction of the wiring lines 83 on a transmission line 70-1 of the suspension. The pads 88 at the edge of the wiring lines 87 are exposed.

When the substrate 85-1 in FIG. 12 is overlapped so that the wiring lines 83 and 87 face each other, each wiring line (pattern) 83 an 87 is connected via the pads 84 and 88, as shown at the right in FIG. 12, and a transmission line having cross points can be created. Solder is used for the connection. The wiring lines 83 and 87 are electrically insulated by the insulation layer 82.

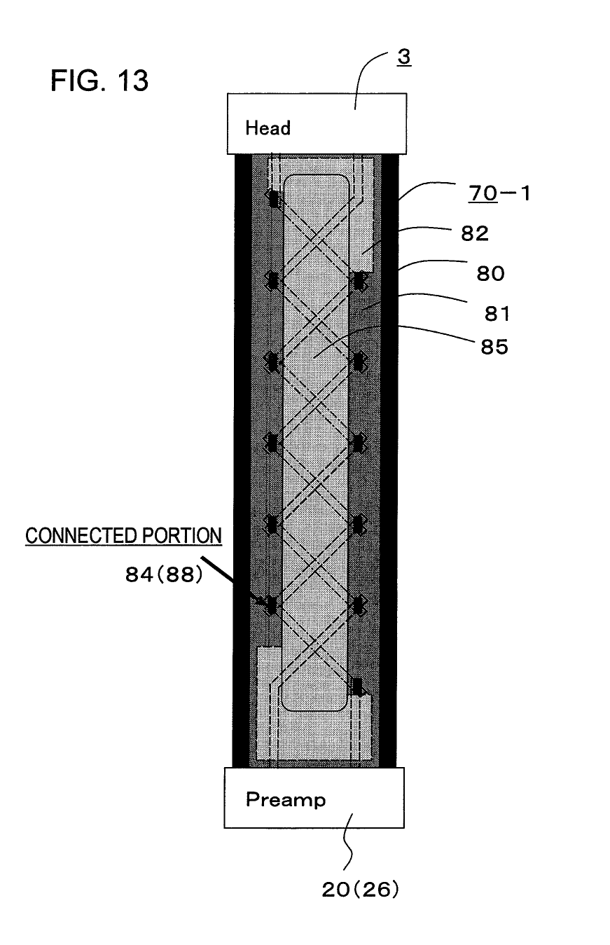

FIG. 13 is a diagram depicting a configuration of a sixth embodiment of the transmission line of the present invention. In FIG. 13, composing elements the same as FIG. 11 are denoted with the same symbols. Just like FIG. 11, in a transmission line 70-1 disposed on the suspension, an insulation layer (e.g. polyimide) 81 is formed on a conductor base 80, and wiring lines (conductor, e.g. copper) 83 are formed diagonally on the insulation layer 81. The wiring lines, except for pads 84 at the edge of the wiring lines 83, are covered by an insulation cover layer 84.

In a flexible printed board 85, the wiring lines 87 are formed diagonally in an opposite direction of the diagonal direction of the wiring lines 83 on the transmission line 70-1 of the suspension on the insulation layer 86 (front side in FIG. 13). The pads 88 at the edge of the wiring lines 87 are exposed. The pads 84 and 88 are connected by applying ultrasonic waves targeting the exposed portions (pads 84 and 88) in FIG. 13. For this, all connection portions are exposed.

If an ultrasonic connection is used, even small portions can easily be connected, and a greater convenience in manufacturing is achieved.

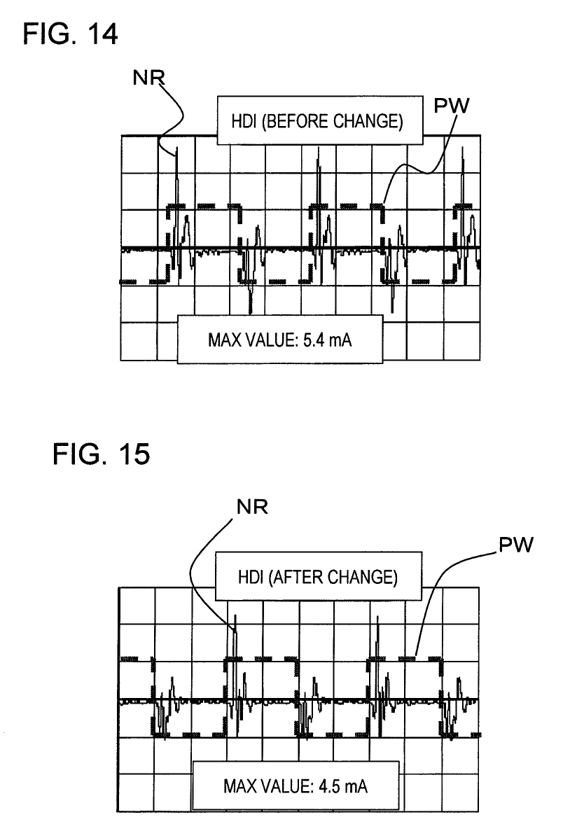

FIG. 14 and FIG. 15 are graphs depicting an effect of the present invention, where FIG. 14 shows a simulation result of noise of the read lines when the transmission line configuration in FIG. 6 is used, and FIG. 15 shows a simulation result of noise of the read lines when the transmission line configuration of the embodiment of the present invention in FIG. 7 is used.

In FIG. 14 and FIG. 15, the dotted line shows the PWM waveform PW, and the solid line shows the injection voltage NR. Comparing FIG. 14 and FIG. 15, the injection voltage NR in FIG. 15 decreases by 10% to 20% compared with FIG. 14.

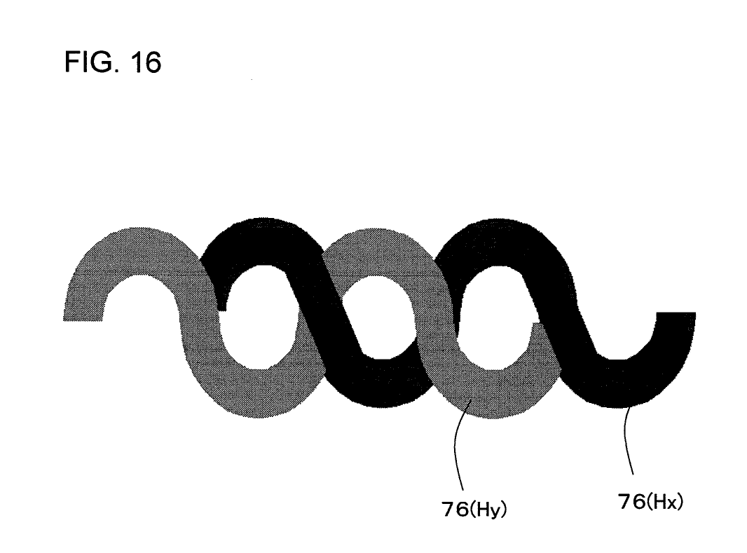

FIG. 16 is a diagram depicting a configuration of a seventh embodiment of the transmission line of the present invention. FIG. 16 shows only the wiring pattern of the heater lines 76. FIG. 16 shows a pattern of a semicircle (Sin waveform), unlike the wedge shape in FIG. 7, FIG. 8, FIG. 9 and FIG. 13. Since a corner (discontinuous point) of the wedge type wiring pattern does not exist, reflection generation can be suppressed, and since the current waveform does not fluctuate, noise generation can be suppressed.

### (Embodiment of Heater Drive Method)

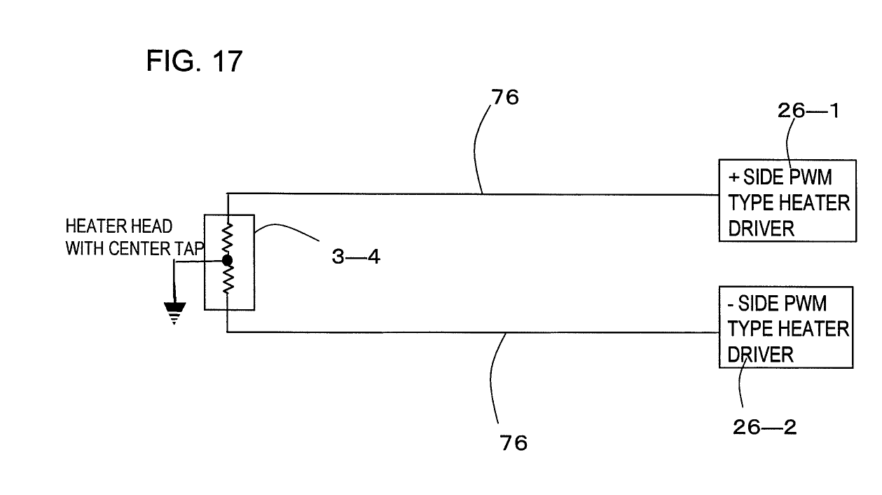

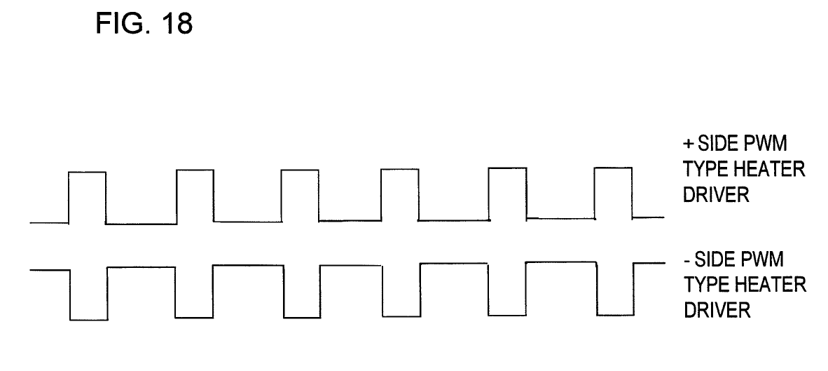

FIG. 17 is a block diagram depicting a heater drive according to an embodiment of the present invention, and FIG. 18 is a waveform diagram of the heater driving thereof. In FIG. 17, the read lines and write lines are omitted. In FIG. 17, the heater element 3-4 of the head 3 is configured by a heater with a center tap. The PWM drive circuit 26 is configured by a plus-side driver 26-1 and a minus-side driver 26-2. These two drivers, 26-1 and 26-2, are connected to one end and the other end of the heater element 3-4 respectively via the transmission lines 76.

By operating the plus-side driver 26-1 and the minus-side driver 26-2 based on a differential operation, as shown in FIG. 18 the minus-side driver 26-2 outputs a minus-PWM waveform, synchronizing with a plus-PWM waveform of the plus-side driver 26-1. Thereby cross-talk currents cancel each other, and noise that enters the signal lines can be decreased.

In other words, the pulse current is sent to the heater element 3-4 without crossing, so noises are cancelled and cross-talk current is decreased. By using a heater with a center tap and a heater drive having both plus and minus functions in this way, a heater which can perform a differential operation can be implemented. As a result, noise can be decreased without changing the current wiring status.

### Other Embodiments

The above embodiments were described using a magnetic disk device where two magnetic disks are installed, but the present invention can also be applied to a device where one magnetic disk or three or more magnetic disks is/are installed. The magnetic head is not limited to the one described in FIG. 2, but the present invention can also be applied to other separation type magnetic heads. The heater drive circuit may not only be installed in the heat IC, but may also be installed at the control circuit side.

The heater drive circuit of the heater element of the magnetic head is constructed by the PWM modulation method, so a pulse width can be adjusted with respect to a predetermined pulse cycle in order to control the amount of power, and therefore the heating of the heater can be controlled with low power consumption. Also the heater drive circuit is comprised of logic system circuits, so the size of the transistors is decreased and the circuit scale can be small. This makes it easier to integrate other functional circuits in the head IC, which is effective to increase the functions of the head IC. Moreover, a pair of heater wiring lines are made of a path in which the signal polarity is inverted and a path in which the signal polarity is not inverted with respect to the read wiring lines, and the heater drive circuit has a configuration to output the pulse width modulation current of the heater element, which has a center tap, as a differential current, therefore cross-talk noise, to the read wiring line, can be decreased even if PWM driving is executed.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

1. A magnetic recording/reproducing device, comprising:
a magnetic recording medium, which rotates;
a magnetic head, which comprises a write element, a separated read element and a heater element;
an actuator, which moves said magnetic head in a radius direction of said magnetic recording medium;
a read amplifier, which is connected to said read element via a pair of read wiring lines and amplifies a signal of said read element;
a write driver, which is connected to said write element via a pair of write wiring lines and drives said write element; and
a heater drive circuit, which is connected to said heater element via a pair of heater wiring lines and drives said heater element by a pulse width modulation method, wherein
said pair of heater wiring lines have one path in which signal polarity is inverted and another path in which signal polarity is not inverted with respect to said read wiring lines.

2. The magnetic recording/reproducing device according to claim 1, wherein said pair of heater wiring lines are twisted in at least one location of said wiring lines so as to form said one path in which said signal polarity is inverted and said another path in which said signal polarity is not inverted.

3. The magnetic recording/reproducing device according to claim 1, wherein said pair of read wiring lines have one path in which a signal polarity is inverted and another path in which a signal polarity is not inverted, with respect to said write wiring lines.

4. The magnetic recording/reproducing device according to claim 1, further comprising a transmission line for connecting a head IC, which has said read amplifier, said write driver and said heater drive circuit, and said magnetic head,
wherein said pair of write wiring lines, read wiring lines and heater wiring lines are disposed in said transmission line.

5. The magnetic recording/reproducing device according to claim 1, wherein said pair of heater wiring lines have at least two transmission plates, each of which has a pair of separate conductor patterns,
and one of said conductor patterns is connected to the other conductor pattern, and said other conductor pattern is connected to said one of the conductor patterns at an overlapped portion of edges of said two transmission plates.

6. The magnetic recording/reproducing device according to claim 1, wherein said pair of heater wiring lines comprises:
a first insulation substrate having a first conductor pattern formed in a first diagonal direction; and
a second insulation substrate having a second conductor pattern which is formed in said first insulation substrate via an insulation layer, in a second diagonal direction which is different from said first diagonal direction,
and edges of said first conductor pattern and said second conductor pattern are inter-connected.

7. The magnetic recording/reproducing device according to claim 6, wherein further comprises a conductive layer which is insulated from said first conductive pattern on said first insulation substrate.

8. The magnetic recording/reproducing device according to claim 6, wherein further comprises a conductive layer which is insulated from said second conductive pattern on said second insulation substrate.

9. A magnetic recording/reproducing device, comprising:
a magnetic recording medium, which rotates;
a magnetic head, which comprises a write element, a separated read element and a heater element;
an actuator, which moves said magnetic head in a radius direction of said magnetic recording medium;
a read amplifier, which is connected to said read element via a pair of read wiring lines and amplifies a signal of said read element;
a write driver, which is connected to said write element via a pair of write wiring lines and drives said write element; and
a heater drive circuit, which is connected to said heater element via a pair of heater wiring lines and drives said heater element by a pulse width modulation method, wherein
said heater drive circuit outputs pulse width modulation current of said heater element having a center tap as a differential current.

10. The magnetic recording/reproducing device according to claim 9, wherein said heater drive circuit outputs a plus-side pulse width modulation current to one of said pair of heater wiring lines, and outputs a minus-side pulse width modulation current, which is in a differential relationship with said plus-side pulse width modulation current, to the other of said pair of heater wiring lines.

11. A magnetic head drive device for driving a magnetic head comprises a write element, a read element and a heater element, comprising:
a read amplifier, which is connected to said read element via a pair of read wiring lines and amplifies a signal of said read element;
a write driver, which is connected to said write element via a pair of write wiring lines and drives said write element; and
a heater drive circuit, which is connected to said heater element via a pair of heater wiring lines and drives said heater element by a pulse width modulation method, wherein
said pair of heater wiring lines have one path in which signal polarity is inverted and another path in which signal polarity is not inverted with respect to said read wiring lines.

12. The magnetic head drive device according to claim 11, wherein said pair of heater wiring lines are twisted in at least one location of said wiring lines so as to form said one path in which said signal polarity is inverted and said another path in which said signal polarity is not inverted.

13. The magnetic head drive device according to claim 11, wherein
said pair of read wiring lines have one path in which signal polarity is inverted and another path in which signal polarity is not inverted with respect to said write wiring lines.

14. The magnetic head drive device according to claim 11, further comprising a transmission line for connecting a head IC, which has said read amplifier, said write driver and said heater drive circuit, and said magnetic head,
wherein said pair of write wiring lines, read wiring lines and heater wiring lines are disposed in said transmission line.

15. The magnetic head drive device according to claim 11, wherein said pair of heater wiring lines have at least two transmission plates, each of which has a pair of separated conductor patterns,
and one of said conductor patterns is connected to the other conductor pattern, and said other conductor pattern is connected to said one of the conductor patterns at an overlapped portion of edges of said two transmission plates.

16. The magnetic head drive device according to claim 11, wherein said pair of heater wiring lines comprises:
a first insulation substrate having a first conductor pattern formed in a first diagonal direction; and
a second insulation substrate having a second conductor pattern which is formed in said first insulation substrate via an insulation layer, in a second diagonal direction which is different from said first diagonal direction,
and edges of said first conductor pattern and said second conductor pattern are inter-connected.

17. The magnetic head drive device according to claim 16, wherein further comprises a conductor layer which is insulated from said first conductive pattern on said first insulation substrate.

18. The magnetic head drive device according to claim 16, wherein further comprises a conductive layer which is insulated from said second conductive pattern on said second insulation substrate.

19. A magnetic head drive device for driving a magnetic head comprises a write element, a read element and a heater element, comprising:
a read amplifier, which is connected to said read element via a pair of read wiring lines and amplifies a signal of said read element;
a write driver, which is connected to said write element via a pair of write wiring lines and drives said write element; and
a heater drive circuit, which is connected to said heater element via a pair of heater wiring lines and drives said heater element by a pulse width modulation method, wherein
said heater drive circuit outputs a pulse width modulation current of said heater element having a center tap as a differential current.

20. The magnetic head drive device according to claim 19, wherein said heater drive circuit outputs a plus-side pulse width modulation current to one of said pair of heater wiring lines, and outputs a minus-side pulse width modulation current, which is in a differential relationship with said plus-side pulse width modulation current, to the other of said pair of heater wiring lines.
